(19) United States
(12) Patent Application Publication
(10) Pub. No.: US 2008/0134296 A1
(43) Pub. Date: Jun. 5, 2008

(54) System and method of network authorization by scoring

(76) Inventors: Ofer Amitai, Tel Aviv (IL); Nir Aran, Raanana (IL)

Correspondence Address: Pearl Cohen Zedek Latzer, LLP, 1500 Broadway, 12th Floor, New York, NY, 10036, US

(21) Appl. No.: 11/606,008

(22) Filed: Nov. 30, 2006

(51) Int. Cl. H04L 9/32

(52) U.S. Cl. 726/4

(57) ABSTRACT

A method and system of grading data elements received from a device and scoring the grades to determine authorization to access a network.

### FIELD OF THE INVENTION

The present invention relates to providing authorization or authentication for a device to access network.

### BACKGROUND OF THE INVENTION

Authorizing or authenticating a device to receive access to a network or network resource may be granted through a set of serial steps. For example, a device seeking access may include an agent, token, password or certificate that may be recognized by a network element. The user may then be required to enter a first password to gain access to a PC system, a second password to gain access to a domain network and a third password to gain access to for example an application. The device must be able to authenticate with many authentication level in order to access the desired network or application. A failure of any of such steps may prevent access of the user or the device from the accessing the resource or application.

### SUMMARY OF THE INVENTION

In some embodiments, a method of the invention may include receiving data elements from a device connected to a virtual network, grading or assigning a grade to indicate for example the existence or confirmation of a data element associated with the device, calculating a score for the device based on the grades, and authorizing access of the device if the score reaches a pre-defined level.

In some embodiments, an element that may be included in the grading may be a request for access made during a certain time of day. In some embodiments, an element that may be included in the grading may be a MAC address or other unique identifier of the device that may recognized by a memory connected to the network. In some embodiments, an element that may be included in the grading may be a particular operating system that may be recognized by a memory. In some embodiments, a grading may be assigned based on a physical location, a host name address, an updated version of an anti-virus program or of a security patch, the presence of a hash file validation or of a particular software program that may be stored in or otherwise associated with the device.

In some embodiments, one or more grades may be weighted, and the weighted grades may be calculated as the score for the device. In some embodiments, one or more pre-defined policies may determine a weight of such data elements. In some embodiments such weighting may be varied based on a presence, absence or condition of one or more of the data elements, or as a result of other conditions. In some embodiments, a minimum score may be required for a device to be granted access to a network resource. In some embodiments the minimum score may be varied according to a pre-determined policy.

In some embodiments, a method may include calculating a score for a device that is seeking access to a network based on data elements of items or components in the device, granting access to a network resource if the score reaches a first level, and granting access to a second network resource if the score reaches a second level.

In some embodiments the required score may be varied to other levels if a particular condition is satisfied or if a sub-score level of certain elements is reached. In some embodiments, a level or score may be varied based on for example a time that access to the network is sought by the device

In some embodiments, a system may include a memory that may store criteria for granting access to the network, and a processor that may collect data from the device, calculate a score based on the collected data elements and compare the calculated score to a pre-determined score.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a conceptual illustration of a system that may provide a device with access to a virtual network, and that may accept and grade a plurality of input elements from said device, in accordance with an embodiment of the invention;

FIG. 2 is a conceptual illustration of a grading table for scoring an authorization calculation in accordance with an embodiment of the invention; and

FIG. 3 is a flow diagram of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “storing”, “comparing” “receiving”, “processing,” “computing,” “calculating,” “determining,” or the like, refer to the action and/or processes of a processor, computer or computing system, or similar electronic computing device, that reads, stores, receives, manipulates and/or transforms data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein. In some embodiments, a series of instructions such as for example software commands may be stored on a medium such as for example a memory device, and the executed instructions may perform an embodiment of the invention.

Some of the structures, units or functions described in this paper may be consolidated or divided into a greater or smaller number of units, structures or functions than are described herein. Some of the structures, units or functions described in this paper may be used or constructed as described in U.S. patent application entitled “SYSTEM AND METHOD OF CHANGING A NETWORK DESIGNATION IN RESPONSE TO DATA RECEIVED FROM A DEVICE”, filed on Nov. 30, 2006, and assigned to the common assignee hereof and incorporated herein by reference.

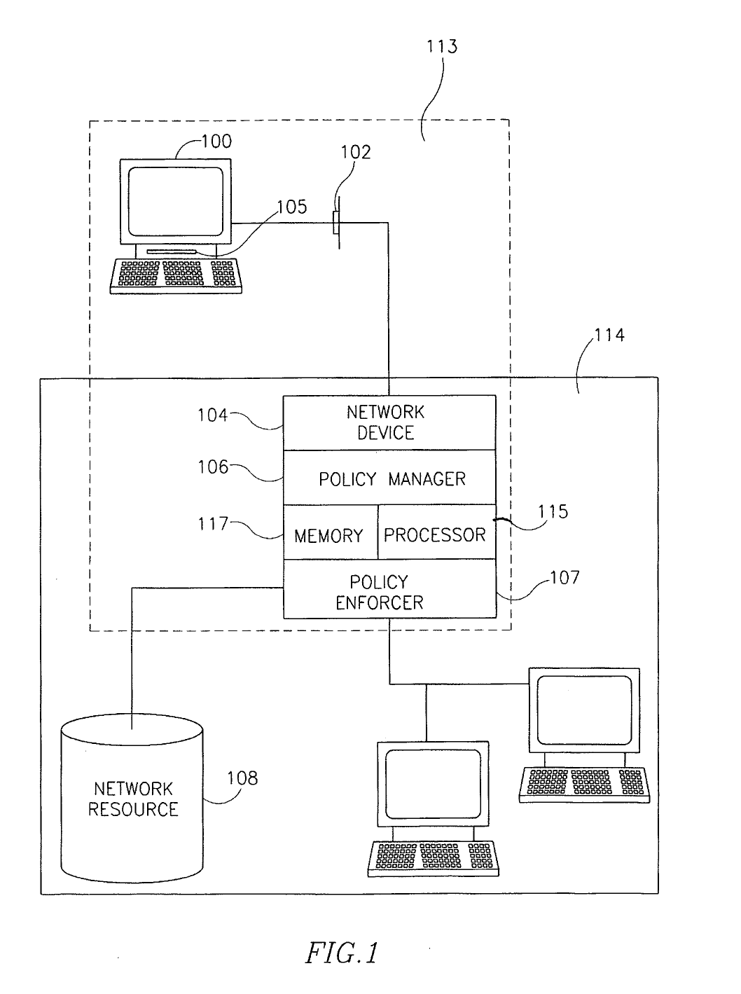

Reference is made to FIG. 1, a conceptual illustration of a system to designate a virtual network that may link with a device connected to for example a port, in accordance with an embodiment of the invention. In some embodiments, an electronic device 100 such as for example a computer, internet telephone, laptop, server, switch, access point, personal digital assistant, email access device or other device, may connect or be connected to a network such as for example by plugging in to for example a port 102 or other outlet that may link to a network or network resource. In some embodiments, port 102 may provide a physical link such as a wired connection between a device 100 and a network device 104 such as for example a switch, router, firewall, access point or server. In some embodiments, port 102 may be or include for example an access point to provide a wireless connection to a network device 104 or network resource component connected to a network, such as for example a policy enforcer 107, that may vary or change a network designation that is associated with device 100 or port 102. In some embodiments, policy enforcer 107 may be included in network device 104, and may create or designate first virtual network (VLAN) 113, that may serve for example as an inspection network or holding area that may include device 100 and port 102. Network device 104 may also have a connection to VLAN 113. In some embodiments upon connection of a device 100 to port 102 or an association of a device 100 with a network element, a notification or link up SNMP trap may be sent from network device 104 to for example policy enforcer 107. This notification message may include for example information indicating that a device 100 has connected with port 102, or may include other information. Policy enforcer 107 may upon receiving such notification or at some other time, configure port 102 or the associated connection between device 100 and an access point, to be a member of a holding or inspection area VLAN, such for example VLAN 113, such that the connected device 100 and port 102 and the policy enforcer 107 will be connected together, but such that device 100 will not have access to other resources of the local area network. While device 100 and port 102 are connected in VLAN 113, other network resources such as network resource 108, may not be available to device 100, and no communication may be established between device 100 and a second layer of communication that may be known as layer 2. In some embodiments, data, signals or packets with a designation representing VLAN 113 may be sent by, to and among device 100, port 102, network element 104 and policy enforcer 107, while data, signals or packets having designations other than representing VLAN 113 may not be sent to or received by device 100 or port 102. The designation of for example VLAN 113 may be recognized by network device 104 as designating only for example an inspection network and devices connected to it. In FIG. 1, the elements included in inspection network using a designation representing VLAN 113, are conceptually illustrated by border 115. No such actual border need exist.

In some embodiments, policy enforcer 107 may access more than one network or VLAN 113 such as for example LAN 114 or other VLANs.

In some embodiments, data about characteristics of the device 100 or components included in the device 100, about port 102 or about other information related to the connection between device 100 and port 102 may be collected in or by a network element 104 that may be accessible to policy enforcer 107. In some embodiments, policy enforcer 107, or some other component associated with a network, may gather information regarding layer 2, for example media access control (MAC) of the connected device 100. The method of collecting information regarding device 100 may include direct SNMP queries to device 100 to fetch the MAC address or other identifying information. In some embodiments collecting data about device 100 or its components may be accomplished by passive probing of the device or transmissions sent by the device such as by for example DHCP relay, DHCP forward, and ARP listening/sniffing. In some embodiments, data about device 100 may be collected by active probing such as by for example WMI Queries, WMI Callbacks, Remote registry, ARP scanning/sniffing, Query Switch ARP Table or port scanning. Other methods are possible.

Policy enforcer 107 or some other component with access to for example VLAN 113, may query device 100 for further data that may identify device 100 as qualified to receive access to a network resource 108. Such data or identifiers may include for example any, some or all of data elements 105 that may identify device 100 or a characteristic of device 100 such as for example a license number for a particular software package that may be installed on device 100, a password or authorization code of device 100, a date that device 100 was last updated with an anti-virus program, a date that device 100 last logged onto the network, or other data by which device 100 may be identified or that may be compared with data stored on for example policy manager 106. In some embodiments, querying of device 100 by policy enforcer 107 or some other component may be achieved using for example expect language, WMI, SNMP, device s fingerprint or other known methods of device querying.

In some embodiments, network device 104 or another device may accept and for example record one, some or all of the data elements 105 or information collected from device 100.

Policy enforcer 107 may query a policy server or policy manager 106 or other list, data base or set of rules or information to receive weights that may be applied to one or more of the data elements 105 that may have been received from device 100. Policy enforcer 107 may include a memory 117 that may store one or more sets of weighting formulas that may be applied to the data elements received from device 100. In some embodiments, a processor 115 that may be connected to policy enforcer 107 may score is the grades on the received data elements 105 in accordance with the weights stored in for example a memory of policy enforcer 107. In some embodiments, one or more weights of grades or data elements 105 may be varied such that a particular weight is assigned to a grade for a data element 105 in some circumstances, while another weight is used in other instances.

In some embodiments a policy enforcer 107 may grant device 100 with access to a first resource based on a first score, but may withhold access to a second resource or application if a second score is not reached by the device. In some embodiments, one or more sub-scores may also be calculated, and access to particular network elements or resources may be determined on the basis of such sub-scores or other criteria relating to the collected data elements. For example, a first score may be sufficient to grant device 100 with access to a network, but device 100 may be directed to an upgrading area where, in a remediation phase, an anti-virus program may be updated on the device 100. Once the upgrade is complete, device 100 may again attempt to gain access to the network, whereupon, a new score may be calculated that may also include the grade for the updated anti-virus program.

In some embodiments, device 100 may not include an agent. In some embodiments, processor 115 that may be connected to for example VLAN 113 may probe, collect or obtain information about components such as software, identification data or other data about a device 100, directly from the components or items that are installed or saved on the device 100. For example, in some embodiments, processor 115 may evaluate a packet or other unit of information that may be sent from device 100 over VLAN 113. Such packet may include for example a MAC address of device 100, domain information of device 100, a hostname of device 100 and other information. In some embodiments, a processor may poll or collect information from any of a hash file validation, file of device 100, a list of driver files or execution files that may be stored on device 100 or other sources of information stored in device 100. Some or all of the information collected by a processor may be included in the data elements 105 that may be evaluated as part of an authorization or authentication process.

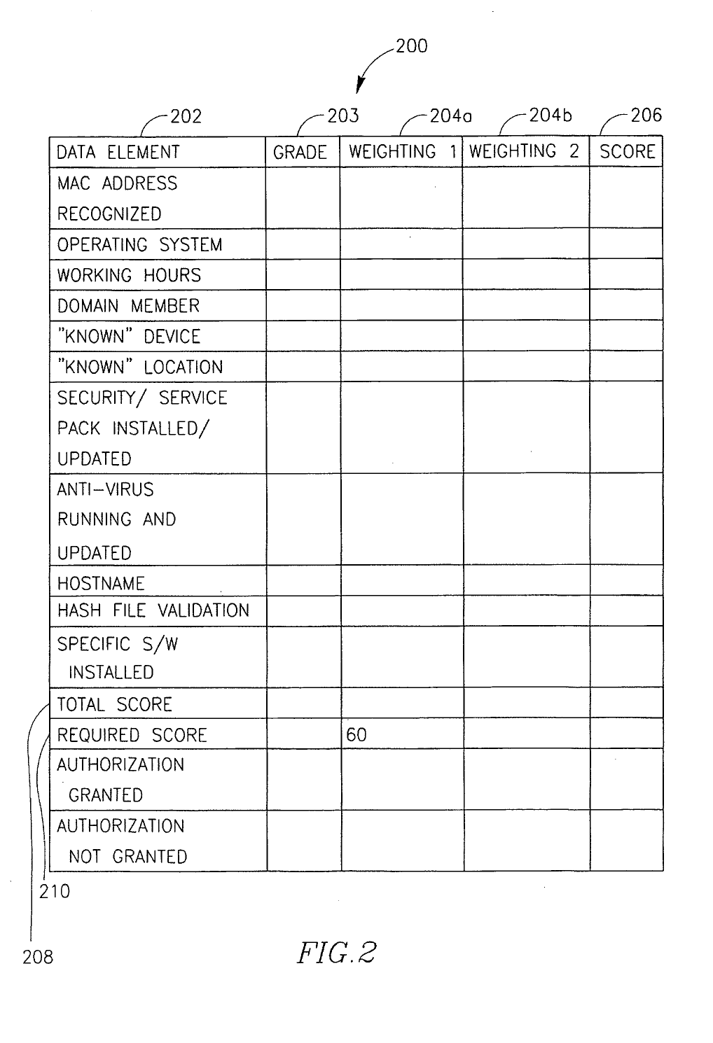

Reference is made to FIG. 2, a conceptual illustration of a grading table for scoring an authorization calculation in accordance with an embodiment of the invention. In some embodiments, a memory may store, record or calculate a table 200 that may include one or more data elements 202 relating to a device that may be connected to a port or a virtual network. Data elements 202 may in some embodiments be inputted by for example a user or administrator of a network or may be pre-programmed into a memory. In some embodiments, table 200 may be stored other than as a table, such as for example an array or other arrangement of memory. One or more of data elements 202 may be associated with one or more weightings 204A and 204B, such that one or more of the grades 203 may be for example multiplied by a relevant weighting 204 to produce a score 206 for a particular data element 202. In some embodiments, a total score 208 for a device that may be connected to a virtual network may be calculated, and compared to a required score 210 for authentication and authorization of the device to gain access to a wider network such as a LAN.

In some embodiments, if a total score 208 reaches or exceeds a required score 210, policy manager 106 or policy enforcer 107 may change a designation of port 102, or other connection or association of device 100, from being a member in VLAN 113 to being for example connected to for example LAN 114. The change in designation of port 102 from being a part of a VLAN 113 to being part of LAN 114 may let signals, packets or data sent to or received from device 100 or over port 102, reach other network resources 108. This change of designation may in effect grant device 100 with access to the wider network that may include network resources 108.

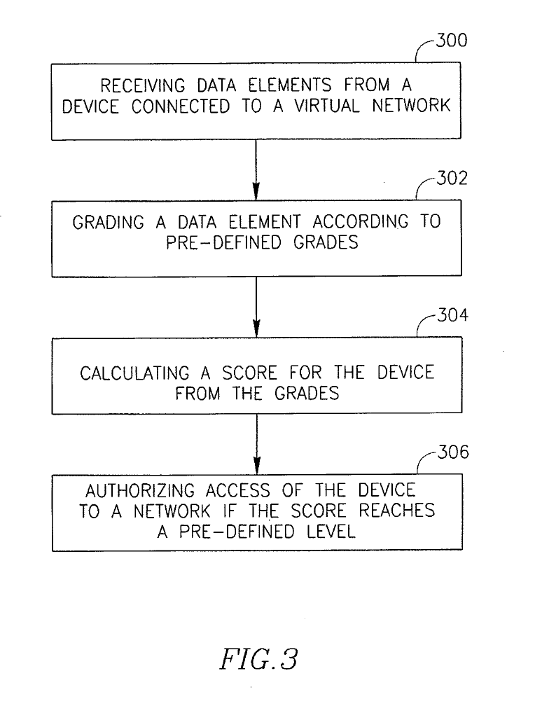

Reference is made to FIG. 3, a flow diagram of a method in accordance with an embodiment of the invention. In block 300, a processor that may be connected to a network, such as for example a processor that may be in an authorization tool may probe a device that is connected to a port, and may receive one or more data elements from the device. The data elements may include information about specific characteristics of the device such as for example a MAC address, a host name, an operating system running on the device, a hash file, an update date for patches or virus software and other information.

In some embodiments, the processor may access a stored list of data elements and a relative importance of such elements in determining an authorization for the device. For example, a table or list of data elements to be received and evaluated by a processor may be input by a user such as an administrator, and the presence or satisfaction by the received data of a data element may be evaluated by the processor.

In block 302, a processor may grade one or more of the listed data elements according to the data received from the device, and may record the grade in for example a table. In some embodiments, a grade may be or include a 1 if a data element received from the device is recognized by a network element such as a policy enforcer. Other grades may be used.

In block 302, a processor may calculate a score for the device that may result from the grades assigned for the collected data elements. In some embodiments, one or more of the grades may be weighted in calculating a total score for the device. For example, a recognized MAC address may be assigned a first weight or importance if the device is attempting to gain access from a known location, but may be assigned a second weight if a device is attempting to gain access from a location that is not recognized.

In block 304, a processor may compare a calculated score for a device to a required minimum score. In block 306, if the calculated score reaches or exceeds the required score, the device may be authorized to gain access to some or all additional network resources. In some embodiments a user such as a network administrator may record more than one policy or weighting for a data element. For example, a grade for a known location may be given a first weight during working hours and a second weight during non-business hours. Other criteria may be considered in scoring or weighing a grade of a collected data element. In some embodiments, a minimum required score may be varied to account for a time or location of a requested access. In some embodiments different minimum required scores may be required in order to gain access to particular network resources. In some embodiments, a minimum required score for access to a network or network resource may be varied if a sub-score reaches a particular level. In some embodiments, a satisfaction of a particular condition or criteria may result in a change of a minimum score that may be required to gain access to a particular resource.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

We claim:

1. A method for:
receiving a plurality of data elements from a device connected to a virtual network;
grading a data element of said plurality of data elements according to pre-defined grades;
calculating a score for said device from said grades; and
authorizing an access of said device to a network if said score reaches a pre-defined level.

2. The method as in claim 1, wherein said grading comprises grading said data according to a time of day of a request for said authorizing said access.

3. The method as in claim 1, wherein said grading comprises grading said data according to a MAC address of said device.

4. The method as in claim 1, wherein said grading comprises grading said data according to an identity of an operating system of said device.

5. The method as in claim 1, wherein said grading comprises grading said data according to a recognized identity of said device.

6. The method as in claim 1, wherein said grading comprises grading said data according to a physical location of said device.

7. The method as in claim 1, comprising varying a weighting of a grade of said data according to a pre-defined policy.

8. The method as in claim 1, comprising comparing said score to a pre-determined minimum score.

9. The method as in claim 8, comprising varying said minimum score in accordance with said pre-determined policy.

10. The method as in claim 1, wherein said grading comprises grading said data according to a parameter selected from the group consisting of a security patch in said device, an anti-virus program in said device, a host name in said device, a hash file validation of said device and a software program installed on said device.

11. A method comprising:
calculating a score for a device seeking access to a network based on a plurality of data elements from said device;
granting access to a first network resource if said score reaches a first level; and
granting access to a second network resource is said score reaches a second level.

12. The method as in claim 11, comprising varying said first level if a score for a data element of said plurality of data elements reaches a third level.

13. The method as in claim 11, comprising varying said first level for a parameter selected from the group consisting of a time of said seeking of said access and a location of said device.

14. A system comprising:
a memory to store a criteria for granting a device with access to a network resource;
a processor, said processor to:
collect a plurality of data elements from said device;
calculate a score for said collected data elements; and
compare said score to said criteria.

15. The system as in claim 14, wherein said memory is to store a weight for a data element of said plurality of data elements.

16. The system as in claim 14, wherein said processor is to vary said criteria if a data element of said plurality of data elements satisfies a condition.

17. The system as in claim 14, wherein said plurality of data elements comprises an identity of an operating system on said device, and wherein said processor is to calculate said score based on said identity of said operating system.

18. The system as in claim 14, wherein said plurality of data elements comprises a recognized identity of said device by said processor, and wherein said processor is to calculate said score based on said recognized identity of said device.

19. The system as in claim 14, wherein said plurality of data elements comprises a physical location of said device, and wherein said processor is to calculate said score based on said physical location.

20. The system as in claim 14, wherein said plurality of data elements comprises a time of a request for access by said device, and wherein said processor is to calculate said score based on said time.
